(19) United States
(12) Patent Application Publication
(10) Pub. No.: US 2006/0117002 A1
(43) Pub. Date: Jun. 1, 2006

(54) Method for search result clustering

(76) Inventor: Bing Swen, Beijing (CN)

Correspondence Address: Dr. Bolesh J. Skutnik, 51 Banbury Lane, West Hartford, CT, 06107, US

(21) Appl. No.: 11/263,820

(22) Filed: Nov. 1, 2005

(30) Foreign Application Priority Data
Nov. 26, 2004 (CN) 200410091772.7

(51) Int. Cl. G06F 17/30

(52) U.S. Cl. 707/4

(57) ABSTRACT

Methods and systems are presented to predetermine and record the classes of each indexed document with respect to each of its index keywords, and to provide high quality and relevant classification of the document when it is searched with said keyword. Document classes, recorded in advance, are used as the clustering information of each document in the search results to realize efficient, large-scale and high quality search result clustering. One embodiment provides a method for search result clustering, which includes recording the classes of each indexed document when the document is searched with each of its index keywords. This method further includes grouping the search results according to the classes of each result document with respect to the keyword or keywords contained in the search query. By prerecording the classes of each document with respect to each index keyword, the classes of each document in the search results in response to a search query can be directly determined via the keywords included in the search query. Each result document is put into each of its classes associated with each of the search keywords, and the union of all the classes of the result documents is used to construct the final document clusters for the search results. The clusters are ranked according to the ranks of documents included in each cluster and the weights of the clustered documents in the corresponding cluster. The clustered search results are presented to the user in such a way that clusters with higher ranks, and documents with higher ranks in each cluster are preferentially presented. Each cluster can be displayed and navigated in an independent framed subarea of the output window.

### RELATED APPLICATION

This application claims priority from the China Patent Application, People's Republic of China Patent Application Serial Number 200410091772.7, in the name of SWEN Bing, entitled “METHOD FOR SEARCH RESULT CLUSTERING”, filed on Nov. 26, 2004, the disclosure of which is incorporated herein by reference in its entirety.

### BACKGROUND OF THE INVENTION

1. Field of the Invention

The present invention relates generally to techniques for document clustering, and more particularly, to methods and systems for clustering a set of documents that are obtained as the results in response to a search request from a searcher using a computer or computer network, for example, a method for clustering the search results generated by an online document retrieval system or an Internet search engine.

2. Description of Related Art

Present-day document retrieval systems based on computer or computer network typically return the search results in response to a user's search request in a ranked list of document representations (including titles, abstracts and hyperlinks), ordered by their estimated relevance to the query included in the search request. Users are supposed to sift through this linear list and select documents that are actually relevant or interesting. For very large document collections such as the web page (HTML or XML document) collections, the returned search result lists typically consist of a large number of documents, the vast majority of which are of no interest to the users (being accustomed to submitting short search queries of very few keywords that may be broadly used and ambiguous). While the ranked list presentation is the simplest and most intuitive way to browse the search results, it would be very difficult and a great burden for the users to find information from a list of hundreds or thousands of candidate documents, which are often heterogeneous in topics, genres and quality.

Ideally, a document retrieval system such as a search engine will automatically group the result documents in the ranked list into subsets of similar or related documents, so as to help the user narrow down the lookup scope and find the desired information more easily and efficiently. A retrieval system may group its documents in two different ways, namely pre-retrieval and post-retrieval grouping. Pre-retrieval document grouping is done prior to processing any search request, grouping the whole document collection into subsets (or called document categories) that remain static before the document collection is rebuilt or updated. Since the categories of each document in the collection are predetermined, the automatic grouping of the documents in search results can be directly and efficiently performed, which is a remarkable advantage of pre-retrieval grouping. On the other hand, for dynamic and highly heterogeneous document collections such as web page collections maintained by search engines, predetermining the categories of each document is typically difficult, costly, of low precision, and a static whole-collection grouping has to be constantly updated and thus inappropriate in such contexts.

Post-retrieval document grouping, or usually called search result clustering, is to group the documents in a search result list into subsets (called document clusters) that are generated and named dynamically (i.e., they may vary with each search result list). Search result clustering has been actively investigated in recent years, mostly in the development of online (on-the-fly) clustering of metasearch engines. A metasearch engine dose not index web documents but, in response to a user's query, queries other (general) search engines and then combines the returned search results to construct its own search result list. The combination process provides an opportunity to apply some lightweight online clustering on the short result document descriptions (called web-snippets) returned by the queried search engines. At present, the best known web-snippet clustering engine is Vivisimo.com and its commercialized version Clusty.com. SnakeT.com is a recently introduced metasearch result clustering engine with a detailed embodiment specification (See Ferragina and Gulli, “A Personalized Search Engine based on Web-snippet Hierarchical Clustering”, Proceedings of WWW2005, the International World Wide Web Conference, 2005). Web-snippet clustering engines reorganize the metasearch results into a hierarchy of clusters that are named by the common substrings (words or phrases) included in the clustered documents, allowing users to navigate through the hierarchy to refine the search. To meet the strict time requirements of online user interaction, all the known metasearch clustering methods have to impose strong limits on the number of document snippets (typically within 200).

Metasearch engine based search result clustering has certain shortcomings and is still a preliminary technology development towards complete and high quality search result clustering. As one may easily verify by experiments, this kind of clustering is typically very slow, small-scale and of low quality. The web-snippets returned from other search engines, as input of the clustering, are highly unpredictable and far from accurate representations of the original web pages, leading to uncontrollable (often very poor) clustering effects. The tree-like organization of clusters commonly used by metasearch clustering engines also makes additional burden of cluster name understanding, document snippet lookup and significantly more hyperlink clicks to locate information.

Thus, there remains a need to improve the efficiency and output quality of the methods and systems for search result clustering.

### OBJECTIVES AND SUMMARY OF THE INVENTION

It is an objective of the present invention to provide innovative techniques for clustering search results within a general document retrieval system architecture, wherein the search results may be efficiently clustered immediately after they are generated.

It is another objective of the invention to provide techniques to rank the generated clusters and the documents in each of the clusters when the search results are clustered.

The invention provides methods and systems to predetermine and record the classes of each indexed document with respect to each of its index keywords, and to provide high quality and relevant classification of the document when it is searched with said keyword. Document classes, recorded in advance, are used as the clustering information of each document in the search results to realize efficient, large-scale and high quality search result clustering. One embodiment provides a method for search result clustering, which includes recording the classes of each indexed document when the document is searched with each of its index keywords. This method further includes grouping the search results according to the classes of each result document with respect to the keyword or keywords contained in the search query.

By prerecording the classes of each document with respect to each index keyword, the classes of each document in the search results in response to a search query can be directly determined via the keywords included in the search query. Each result document is put into each of its classes associated with each of the search keywords, and the union of all the classes of the result documents is used to construct the final document clusters for the search results. The clusters are ranked according to the ranks of documents included in each cluster and the weights of the clustered documents in the corresponding cluster. The clustered search results are presented to the user in such a way that clusters with higher ranks, and documents with higher ranks in each cluster are preferentially presented. Each cluster is able to be displayed and navigated in an independent framed subarea of the output window.

Additional aspects and advantages will become apparent in view of the following detailed description and associated figures.

### BRIEF DESCRIPTION OF THE DRAWINGS

The four accompanying drawings illustrate an embodiment of the invention.

FIG. 1 is a flowchart of exemplary processing for clustering search results according to an embodiment consistent with the principles of the invention.

FIG. 2 is an exemplary diagram of the inverted index data structure that is extended with the keyword-associated clustering information of indexed documents according to an embodiment consistent with the principles of the invention.

FIG. 3 is a screen shot illustrating exemplary screen display of the top 3 clusters of the clustered search results for the query “search engine” according to an embodiment consistent with the principles of the invention.

FIG. 4 is a screen shot illustrating exemplary screen display of FIG. 3 with the framed subarea of the second document cluster being independently closed and the following clusters being hence scrolled up in the output window.

### DETAILED DESCRIPTION OF THE INVENTION

Methods and systems consistent with the principles of the invention may be implemented within conventional document retrieval system architectures, such as an Internet search engine. As would be known by anyone of ordinary skill in the art, a document retrieval system based on computer or computer network includes the following major components, namely a document collection, an indexing component for building an index of the document collection, and a retrieval (or search) component that in response to a search query, identifies via the index a subset of documents as the search results that are relevant (by some ranking criteria) to the query. A document collection typically consists of a certain number of electronic documents of various formats, such as text files or HTML web pages, etc. A document collection is updated whenever documents are added to or removed from it. Large-scale document retrieval systems generally use inverted indexes, i.e., indexes that record for each keyword (called an index keyword) a list of documents that contain that keyword. Such a list is usually termed an inverted list. An inverted index consists of many inverted lists, each of which corresponds to an index keyword. In many cases the inverted index may include more information on the frequency, occurrence positions and text formats of each keyword in each document. A document may contain many keywords, and hence may be included by many inverted lists.

Assuming a collection of documents {dᵢ|i=1, 2, . . . , I}, where I is the number of documents. A document retrieval system indexes these documents with a set of keywords {kwⱼ|j=1, 2, . . . , J}. The process of document retrieval is the search of the index using the keywords included in a query, which is typically a single keyword, or a logic expression of several keywords. Let Query include the keywords kw₁, kw₂, . . . , kw_{Q}, denoted by Query={kw₁, kw₂, . . . , kw_{Q}}. The set of all the documents containing a search keyword kwᵢ can be directly retrieved via the inverted list of kwᵢ in the index. The set of documents relevant to Query may be efficiently constructed with the documents in the inverted lists of keywords kw₁, kw₂, . . . , kw_{Q} (with proper set operations such as union, intersection, etc.). The system may then rank the relevant documents using some criteria (such as word frequency, order, position or text format, or cross references between documents) and assigns a score to each document as a measure of the relevance degree to the query. The final list of search results is constructed by selecting a certain number (e.g., 1000) of top ranked relevant documents and sorting them reversely by their relevance scores. After generating a representation (typically including a title, a keyword-in-context abstract, and a hyperlink) for each of the result documents, the search result list may be properly organized with a display page and sent to the user. In the field of information retrieval, the term “keyword” is referred to as a term for indexing and searching, which should be interpreted broadly to include a word, a phrase of words, or any other kinds of character strings (for example, a bigram), as the term is used herein.

Instead of applying some kind of lightweight clustering algorithms on the generated document representation (or any intermediate data) list of search results as in the case of current metasearch result clustering techniques, the search result clustering method of the present invention uses some particular pre-retrieval processing on the documents and their inverted index to facilitate more efficient techniques for determining and ranking the clusters of result documents.

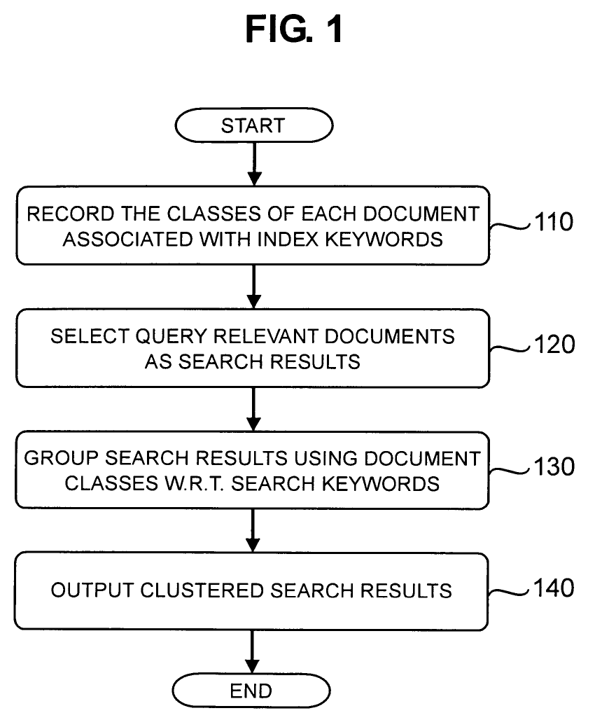

FIG. 1 is a flowchart of exemplary processing for clustering search results according to an embodiment consistent with the principles of the invention, where the search results may be generated with a conventional document retrieval system. Processing may begin with recording the classes of each indexed document when it is assumed to be searched with each of its index keywords (act 110). The classes may include all the possible (or the most important or frequently used) classes of the document when it is searched (and hence indexed) with each specific index keyword.

Assume that the document collection is {dᵢ|i=1, 2, . . . , I}. Act 110 is to prerecord a set of classes of each document dᵢ with respect to at least part of dᵢ's index keywords. This class set of dᵢ with respect to a keyword kwⱼ is denoted by KWAC_Set {kwⱼ, d)=(Cₘ, m=1, 2, . . . , M}, and since the document classes Cₘ are keyword associated, they are herein called “KWAC classes” (Keyword Associated Clustering classes). Prerecording the KWAC classes of each indexed document (act 110) may be performed at any pre-retrieval time, preferentially at the phase of building the index of the document collection, either as an independent process or as an integrated subroutine of the indexing. Contents of this step will be discussed in more detail below.

The processing may include generating the search results in response to a search query by selecting and ranking a set of documents that are relevant to the search query via the inverted index (act 120), in the same way as the conventional systems described above. The search query may contain a certain number of keywords, and may be submitted with a search request from a searcher using a computer or computer network.

The search results may then be grouped into a certain number of document clusters via the KWAC class sets of the result documents with respect to the query keywords (act 130). Each result document may be put into each of its classes associated with each of the search keywords, and the union of all the classes of the result documents may be used to construct the final document clusters for the search results. The clusters may be ranked according to the ranks of documents included in each cluster and the associative weights of the clustered documents with the corresponding cluster, such that clusters with higher ranks and documents with higher ranks in each of the clusters may be identified first. More details of this step will be discussed below.

Clustered search results may then be organized for display and sent to the user (act 140).

The exemplary processing of FIG. 1 may be implemented with a document retrieval system to combine the clustering of search results with document indexing, retrieval and ranking. Such embodiments are not limited to metasearch clustering engines. More aspects and details of the processing of FIG. 1 are presented in the following sections.

### Determining the Classes of Documents for Clustering

The keyword-associated clustering classes of the present invention may be determined off-line at any time prior to processing search queries, which provides advantages for improving runtime efficiency as well as clustering quality. The document classes for clustering may be any kind of classification tags, or any identifiers defined by the system. Clustering techniques consistent with the principles of the invention can be applied to any kind of document classes in a straightforward manner. For present large-scale document retrieval systems, such as Internet search engines, one kind of class identifiers that is particularly useful for setting up readable and comprehensible cluster names is keywords, namely, the name of a document KWAC class and the search result cluster generated from it is denoted by a keyword (or phrase) that are related to search keywords. Such types of cluster names facilitate keyword-based browsing of clustered search results.

Flexible combinations of keyword classes and other class identifiers may be used. For example, document classes from a conventional classification system (such as a web page directory like the Open Directory Project, http://www.dmoz.com) can be used as the KWAC classes of a document associated with some index keyword(s) when there are no appropriate keywords that are related to the index keyword(s) in the document.

In one particular embodiment, keyword collocations may be used as a source of clustering classes. First, a phrase library is used to record frequently used or important combinations of keywords. When an index keyword of a document satisfies some collocating relations recorded in the phrase library, the keywords collocating with the index keyword can be used as one of the KWAC classes of the document with respect to that index keyword. Second, statistical natural language processing (NLP) techniques of identifying phrases and stable word co-occurrences are used to obtain new collocations from the indexed documents, and the document classes with respect to the keywords from the identified collocations are determined the same way as above. In addition, new collocations are added to the phrase library to help determine the clustering classes of other documents.

Words or phrases related to the topics of a document can be directly used as the clustering classes of the document with respect to other keywords (or any other index terms such as bigrams). The format information of web pages or other formatted documents may be used as the basis of topic words. In particular, keywords in document titles, as well as keywords in link text (often called anchor text) of the hyperlinks pointing to present indexed document, may preferentially become candidate topic words of the present document and the clustering classes of some of its index keywords.

According to an embodiment consistent with the principles of the invention, a set of synonymous or similar words are used to denote the classes of a document with respect to another keyword or keyword phrase, or another set of synonymous or similar words. Such a word set is called a synonym set or synset by the WordNet project (http://wordnet.princeton.edu). WordNet has been extensively used in the research and application of information retrieval, and currently there are multilingual versions of the WordNet database (http://www.globalwordnet.org). The well-formed synset network may be used here as the classes to cluster the search result documents with respect to a query keyword. In one particular embodiment, a searched document containing any of the words in a synset C, that is closely related to the search query, are clustered into the class C.

A synthetic method using the above factors to determine the clustering classes of each document is as follows: First, a group of possible classes {Cₗ(kw), l=1, 2, . . . , L} of all the documents in the collection is determined when the search query is assumed to be a specific index keyword kw. The class set for each index keyword kw may integrate all the factors as described above, and the conditions to put a document into each possible class Cₗ(kw) may be supplemented. Such class sets are independent to a specific document, representing global usage of index keywords. Second, the clustering classes of each document with respect to a keyword kw are determined by testing whether the document can be put into to each of the global classes Cₗ (kw), preferably done when the document is indexed. Then all the determined classes Cₗ (kw) of a document d when d is searched with keyword kw make the actual clustering class set of d,
KWAC_Set (kw, d)={Cₘ(kw), m=1, 2, . . . ,M}.
This class set is recorded in advance (at the indexing phase), presenting appropriate classification of document d when the search query includes keyword kw.

For important index keywords, their global class sets can be manually checked and/or corrected to improve the quality of search result clustering. For example, a search engine may predetermine high quality clustering class sets for a group of most frequently searched keywords with broad usage and collocations (such as “virus”, “notebook”, “mp3”, “engine” etc.) by employing the above technique, where the top clustering classes of these keywords may be obtained through extensive processing of the whole document collection using linguistic resources (such as large word dictionaries, phrase and collocation dictionaries, semantic dictionaries) and statistical corpus handling methods. Human resources may then be employed to check and correct the output results.

The global class sets of index keywords could have been directly used for search result clustering once they have been obtained at the first step of the above processing, i.e., when a set of ranked relevant documents are obtained in response to a query including keyword kw, these documents can then be grouped according to the global class set of kw {Cₗ(kw), l=1, 2, . . . , L} along with the conditions of each class Cₗ(kw). For the judgment of classifying each of the result documents into Cₗ(kw), additional information of the documents must be provided, e.g., the simplest form would be the forward index (or document vectors). Such an online (on-the-fly) classification via global class sets of index keywords may be applicable for some relatively simple cases. On the other hand, the above second step that determines KWAC_Set (kw, d) for each index keyword and each indexed document is an offline pre-classification of the indexed documents. The preprocessed information in the class sets KWAC_Set(kw, d) facilitates large-scale, efficient and high quality search result clustering.

According to an embodiment consistent with the principles of the invention, each clustering class Cᵢ(i=1, 2, . . . ) of document d with respect to keyword kw has a weight wtᵢ,
wtᵢ=KWAC_Weight (kw, d, Cᵢ) (1.)

which stands for the weight or possibility of a document d belonging to the class Cᵢ when d is indexed (as well as searched) by keyword kw. wtᵢ may be determined when the document is indexed. For all classes of d with respect to a index keyword kw, namely for all elements in a class set KWAC_Set(kw, d), a constraint condition on the class weights may be introduced for the comparability of the weights, namely for any kw and d:

$${a}_{{C}_{i} \hat{I} KWAC\_Set ( kw , d )}^{°} KWAC\_Weight ( kw , d , {C}_{i} ) = 1. \qquad ( 2. )$$

The simplest case of class weights is that all the classes in a class set KWAC_Set (kw, d) is equally weighted (of equal importance), with values being the reciprocal of the number of classes in the set,

$$KWAC\_Weight ( kw , d , {C}_{i} ) = \frac{1}{\vert KWAC\_Set ( kw , d ) \vert} . \qquad ( 3. )$$

For clustering class Cᵢ that are keywords, class weights may be determined by the co-occurrence frequencies fᵢ of the keyword Cᵢ and the index keyword kw. In one particular embodiment, for a class set KWAC_Set (kw, d)={Cᵢ, i=1, 2, . . . , M}, the class weights are set as follows:

$${wt}_{i} = \frac{{f}_{i}}{{f}_{1} + {f}_{2} + … + {f}_{M}} , i = 1 , 2 , … , M \qquad ( 4. )$$

Besides co-occurrence frequencies, other statistical quantities (such as mutual information) can also be used as the basis to determine the weights of clustering classes.

For keyword classes Cᵢ, their weights may be defined or further adjusted by the occurrence positions, text formats and word proximity information of the keywords Cᵢ in a document d, in accordance with conventional document retrieval techniques for term weighting. For example, when the keyword Cᵢ is a neighbor of index keyword kw, or when they co-occur in the document title, then the value of KWAC_Weight (kw, d, Cᵢ) is increased accordingly.

The classes in a set KWAC_Set (kw, d) can be hierarchically organized. The search result clustering method of this invention can be applied the same way for both hierarchical and flat document classes. Flat classes, as used by the embodiments described below, may help improve runtime and storage efficiency, and provide more convenient browsing of clustered search results. In addition, the processes of identifying clustering classes and class weighting are independent to the process of handling search queries, and thus may all be performed offline.

### Organization and Storage of Clustering Classes

According to an embodiment consistent with the principles of the invention, the keyword-associated clustering information is a set of entries represented by (index keyword, document id) pairs. Such set may be organized as a 2-dimensional table data structure, stored in files. It may be further organized as a set of inverted lists with (keyword, document id list) pairs. These inverted lists may be stored and accessed in disk files. These inverted lists can be combined with the inverted index of documents if appropriate data fields are added to the inverted index.

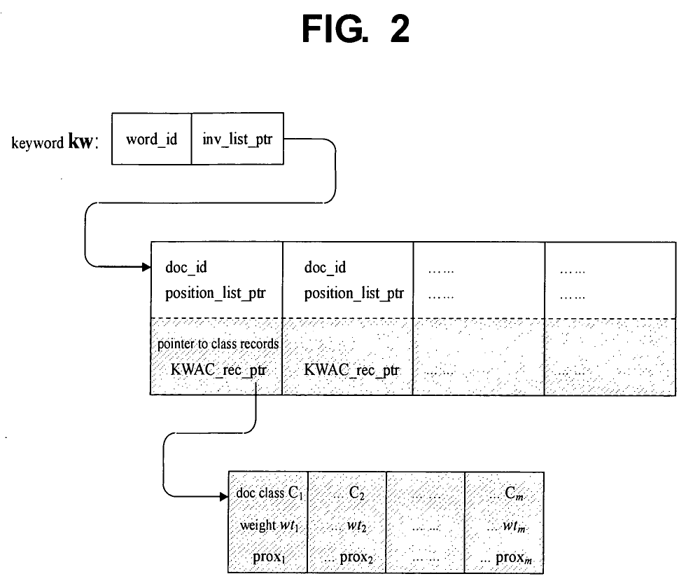

FIG. 2 is an exemplary diagram of the inverted index data structure that is extended with the keyword-associated clustering information for each of the indexed documents. Each of the index terms, denoted by keyword kw, is represented by an integer called word_id (via an index lexicon), which has a specific pointer data field inv_list_ptr that points to an inverted list of the index, specifying the starting address and the size of the list. Each indexed document in the inverted index list has a document-id field doc_id, and a pointer to the list of records that include the information of occurrence positions and text formats of keyword word_id in document doc_id, which is denoted by position_list_ptr in the diagram. The shadowed area in FIG. 2 is the extended clustering class information organized to be combined with the inverted index according to an embodiment of the invention. Each document record in the inverted index list is extended with a point field, denoted by KWAC_rec_ptr, that points to a list of records of all the predetermined KWAC classes C_{1,2, . . . , m}, along with the corresponding class weights wt_{1,2, . . . ,m}, for current document doc_id with respect to the index keyword word_id. In one particular embodiment where keywords are used as KWAC classes, the clustering classes C_{1,2, . . . ,m} are the corresponding word ids of the keywords C_{1,2, . . . ,m}.

Additionally, a proximity field prox_{1,2, . . . ,m} is set in each of the clustering class records, which is used to indicate whether each class keyword Cᵢ is a neighbor of the index keyword kw. proxᵢ=+n, −n or 0 if Cᵢ is on the right-hand side, left-hand side, or not a neighbor of kw, where integer n stands for the distance (in words or bytes) between the words Cᵢ and kw in document doc_id. The integer n is closely related to the class weight wtᵢ, such that the larger n is the less wtᵢ is.

### Determining the Clusters of Documents in Search Results

According to an embodiment consistent with the principles of the invention, for search queries consisting of a single keyword, Query={kw}, any document d in the search results may be put into each of the KWAC classes of d with respect to the search keyword kw, that is, document d may appear in all the classes Cᵢ∈KWAC_Set (kw, d). The final clusters of the search results can be obtained by incorporating the classes of all the documents in the search results, which accomplishes the grouping of search results.

In a further embodiment, for keyword KWAC classes Cᵢ, the names of document clusters obtained for single-keyword queries can be determined as follows:

If the KWAC class of d with respect to kw is Cᵢ that is a right neighbor word of kw (namely proxᵢ=+1), then the cluster name is denoted by “kw Cᵢ”;

If the KWAC class of d with respect to kw is Cᵢ that is a left neighbor word of kw (namely proxᵢ=−1), then the cluster name is denoted by “Cᵢ kw”;

Otherwise, the cluster name is denoted by “kw, Cᵢ”.

For classes Cᵢ consisting of multiple keywords that do not collocate with each other, their cluster names are determined according to the last case above.

For search queries consisting of multiple keywords, Query={kw₁, kw₂, . . . , kw_{Q}}, the search result clustering is related to the logic relations of the query keywords. For multi-keyword queries with the logic AND relation, the clusters of a document d with respect to the whole query are the union of the KWAC class sets of d with respect to each of the query keywords, namely

$$KWAC \text{-} Set ( Query , d ) = {U}_{kwl Query} KWAC\_Set ( kw , d ) . \qquad ( 5. )$$

The documents to be clustered in the search result list already contain all the keywords with the AND relation, and thus determining the class union of a document with respect to the keywords can be straightforwardly processed. The process of getting the documents in each cluster is the same as that of grouping search results of single-keyword queries. Documents in the search results are put into each of the clustering class Cᵢ∈KWAC_Set (kw, d). The final clusters are obtained by incorporating the classes of all the result documents.

For search queries consisting of multiple keywords with the logic OR relation, the clusters of a document with respect to the query are the class set of the document with respect to the specific query keyword that the document contains. The process of determining the documents in each cluster is the same as that of grouping search results of single-keyword queries.

And for search queries consisting of multiple keywords Query={kw₁, kw₂, . . . , kw_{Q}}, wherein some of the keywords are of the logic NOT relation, the documents in the search results are obtained by eliminating those documents that contain the keywords of the NOT relation. In this case, the clusters of a result document with respect to the query are determined as described above with only the query keywords that are not of the logic NOT relation.

In an embodiment consistent with the principles of the invention, for keyword KWAC classes Cᵢ, the names of document clusters obtained for multi-keyword queries can be determined as follows:

If the keywords in the query are not required for proximity (e.g., keywords joined with logic relations such as AND, OR, etc.), then the document cluster names associated with each of the query keywords can be determined in the same way as that of single-keyword queries;

If the proximity of keywords in the queries is important, such as a phrase “A B” (the keywords “A” and “B” must be in close proximity and order, and with the AND relation), then the cluster names associated with queries including a phrase “A B” can be determined as follows:

If the KWAC class of d with respect to “B” is C₁ that is a right neighbor word of “B” (proxᵢ=+1), then d is put into the cluster C₁, and the cluster name are denoted by “A B C₁”;
If the KWAC class of d with respect to “A” is C₂ that is a left neighbor word of “A” (proxᵢ=−1), then d is put into the cluster C₂, and the cluster name are denoted by “C₂ A B”;

If both of the above cases hold, then d is put into the two clusters C₁ and C₂, with cluster names specified respectively above;

Otherwise, d is put into the clusters of the KWAC classes Cᵢ and Cⱼ of d with respect to independent keywords “A” and “B”, and the cluster names are denoted by “Cᵢ, A B” and “A B, Cⱼ” respectively.

For example, when Query=“search engine” (assuming the query is turned into two keywords “search” and “engine” via the index lexicon), the proximity of the two keywords are important (conventionally, keywords included in quotation marks indicate searching only for phrase occurrences). If d's right-proximity KWAC class associated with “engine” is “marketing”, then d is put into a cluster named “search engine marketing”. If d's left-proximity KWAC class associated with “search” is “Internet”, then d is put into a cluster named “Internet search engine”. If both cases hold, then d is put into the two clusters “search engine marketing” and “Internet search engine”. Otherwise, the query can be treated as two keywords “search” and “engine” without proximity requirements.

Queries including phrases of the form “A . . . B” can be handled the same way.

For multi-keyword queries including keywords both with and without proximity requirements, e.g., Query={“AB”, C, D}, keywords without proximity requirements may be first handled as above, and then keywords with proximity requirements may be handled.

For multi-keyword queries with the logic OR relation, keywords associated with the AND relation are first processed as described above, and each of the OR associated parts are taken as independent (sub)quires, with the cluster names independently determined. For multi-keyword queries with the logic NOT relation, only keywords that are not of the NOT relation are processed as described above.

### Computing the Ranks of Documents in Clusters

A document d that is selected as a search result in response to a query typically has a score as the estimated relevance to the query (or as a measure of the importance of the document), which is used for ranking and sorting the search result list. Let this score of d be denoted by DocRank(d). Embodiments consistent with the principles of the invention adjust or recompute the score of a document when it is put into a cluster. In one particular embodiment, a document with score DocRank(d) has a new score ClusteredDocRank(d, Cᵢ) when it is clustered into a keyword associated class Cᵢ∈KWAC_Set (kw, d), defined as follows:

$$\begin{matrix}ClusteredDocRank ( d , {C}_{i} ) = {a}_{kwl Query}^{∘} ClusteredDocRank ( kw , d , {C}_{i} ) . \\ where & ( 6. ) \\ ClusteredDocRank ( kw , d , {C}_{i} ) = {DocRank ( d )}^{′} KWAC\_Weight {( kw , d , {C}_{i} )}^{′} {f ( KWAC\_Freq ( Query , d , {C}_{i} ) )}^{′} g ( Mutual\_KWAC ( Query , d ) ) . & ( 7. )\end{matrix}$$

In the above formula, KWAC_Weight (kw, d, Cᵢ)=Wtᵢ is the weight of d when it is in one of its clustering class Cᵢ∈KWAC(kw, d) that is associated with the index keyword kw;

KWAC_Freq (Query, d, Cᵢ) is the number of times that class Cᵢ appears in all of d's class sets KWAC_Set (kw∈Query, d) that are associated with the keywords in the query, and the function f can take one of the two typical forms f(x)=x or f(x)=2^{x} depending on the particular situation and embodiment;

And the function Mutual_KWAC (Query, d) stands for the number of the keywords in the query kw∈Query that are mutually the clustering classes of each other in document d's KWAC records; function g(x) may take the form g(x)=x according to a further embodiment.

According to the embodiment, for multi-keyword queries, if a clustering class Cᵢ is an element of the KWAC sets of multiple query keywords in document d, then for the present query the importance of class Cᵢ to d is increased by a factor f (KWAC_Freq (Query, d, Cᵢ)). If class Cᵢ appears in fewer class sets of the query keywords (e.g., in only one keyword's KWAC set), then the importance of Cᵢ is lowered correspondingly.

Additionally, according to the embodiment, if there are multiple keywords in the query that belong to the KWAC class sets of each others in document d, namely, for two query keywords kw_{i,j∈Query,}
kwᵢ∈KWAC_Set (kwⱼ, d) and
kwⱼ∈KWAC_Set (kwᵢ, d),
then the document d may be more important for the query, and thus d has a larger rank, increased by a factor g(Mutual_KWAC (Query, d)). In a particular situation, when all the n keywords of a query are mutually the KWAC classes of each other in d, then the rank of d may be multiplied g(n) times.

Documents that are clustered in any class Cᵢ are sorted by their above ranks in the cluster, namely, by ClusteredDocRank (d, Cᵢ).

### Computing the Ranks of Clusters

In response to a search query, when the selected relevant documents are grouped into all the possible clusters that are determined via the KWAC class records information, the rank of each of the clusters can be computed with the ranks of documents that are grouped into this cluster. According to an embodiment consistent with the principles of the invention, the rank of a cluster is the sum, or the average, of the ranks of all the documents (or the top N documents) that are included by the cluster, depending on the particular situation and embodiment options.

According to a further embodiment, for a search query, Query={kw, . . . } (with single or multiple keywords), the rank of a cluster Cᵢ can be determined via one of the following two manners:

$$\begin{matrix}{ClassRank}_{1} ( {C}_{i} ) = {a}_{d \hat{I} {C}_{i}}^{∘} ClusteredDocRank ( d , {C}_{i} ) = {a}_{d \hat{I} {C}_{i}}^{∘} {a}_{kw \hat{l} Query}^{∘} ClusteredDocRank ( kw , d , {C}_{i} ) & ( 8. ) \\ {ClassRank}_{2} ( {C}_{i} ) = {a}_{d \hat{I} {C}_{i}}^{∘} \frac{ClusteredDocRank ( d , {C}_{i} )}{{N}_{Docs} ( {C}_{i} )} = {a}_{d \hat{I} {C}_{i}}^{∘} {a}_{kw \hat{l} Query}^{∘} \frac{ClusteredDocRank ( kw , d , {C}_{i} )}{{N}_{Docs} ( {C}_{i} )} , & ( 9. )\end{matrix}$$

Where N_{Docs}(Cᵢ) the total number of documents clustered in Cᵢ.

ClassRank₁ and ClassRank₂ are the sum and the average of the ranks of clustered documents respectively. ClassRank₁(Cᵢ) is used to denote the overall importance of the cluster Cᵢ (whether this cluster should be presented first to the user). ClassRank₂(Cᵢ) is used to denote the average importance of the documents of Cᵢ (whether the documents of this cluster should be seen earlier by the user). ClassRank₁ may be a better ranking when the numbers of documents in the clusters are very different. ClassRank₂ may be a better ranking when the document numbers as well as the quality (ranks) of the documents in the clusters are close or comparable to each other (or when they are trimmed to be so).

Clusters obtained from the search results are sorted by their ranks (in either ClassRank₂, or ClassRank₂). In addition, the clustered documents in each cluster are sorted by their ranks. When the clustered search results are to be presented to the user, clusters with higher ranks, and documents with higher ranks in each cluster, are preferentially presented.

In one particular embodiment, a new document rank score is computed for a document in the search results after the document is clustered via its KWAC records information. For a document with initial rank DocRank (d), a new rank of d with respect to the search query can be introduced from the above formula (7):

$$NewDocRank ( d \text{\vert} Query ) = {a}_{kw \hat{l} Query}^{∘} {a}_{{C}_{i} \hat{I} KWAC\_Set ( kw , d )}^{°} ClusteredDocRank ( kw , d , {C}_{i} ) = {DocRank ( d )}^{′} {a}_{kw \hat{l} Query}^{∘} {a}_{{C}_{i} \hat{I} KWAC\_Set ( kw , d )}^{°} [ KWAC\_Weight {( kw , d , {C}_{i} )}^{′} {f ( KWAC\_Freq ( Query , d , {C}_{i} ) )}^{′} g ( Mutual\_KWAC ( Query , d ) ) ] , \qquad ( 10. )$$

where the various quantities are defined as above. Under the condition of formula (2), NewDocRank is reduced to the initial DocRank for f(x)=1 and g(x)=1/Q (where Q is the number of keywords in the query).

According to the embodiment, NewDocRank can be used to re-rank the documents in the search results when the user opts not to cluster the search results for a particular query while the clustering information is still turned on.

### Outputting the Clustered Search Results

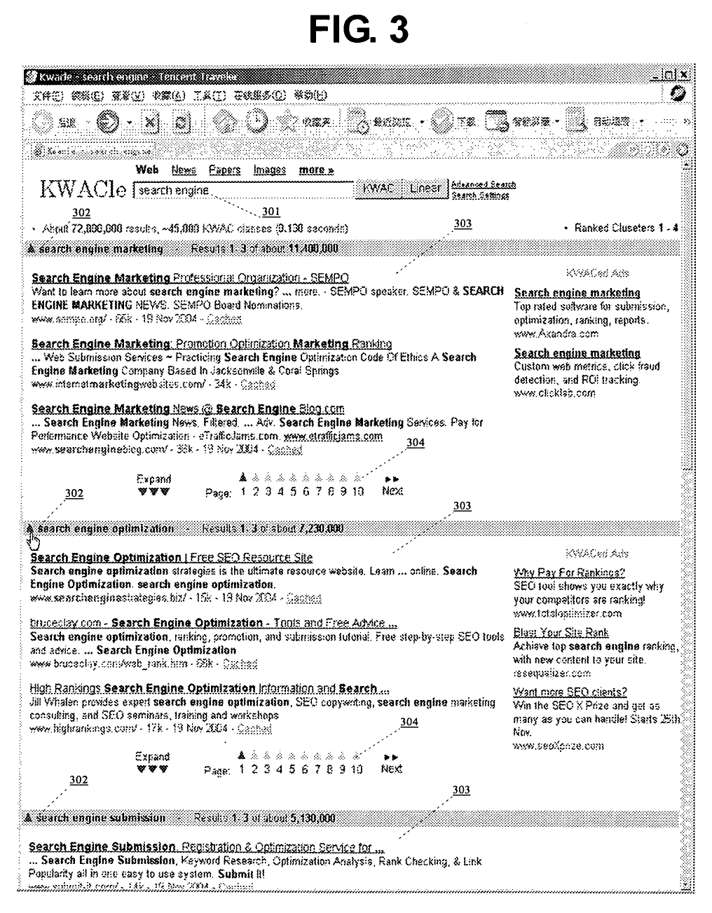

In an embodiment consistent with the principles of the invention, search results that are clustered by the prerecorded clustering class information may be organized in a display page and sent to the user (act 140 of the exemplary processing of FIG. 1). FIG. 3 is a screen shot illustrating exemplary screen display of the top three clusters of the clustered search results for the query “search engine” 301. The search results are grouped into multiple clusters, correspondingly named as “search engine marketing”, “search engine optimization”, “search engine submission”, etc. The clusters are sorted by their ranks as determined by ClassRank₁, as defined by formula (8). Documents in each cluster Cᵢ are sorted by their ranks ClusteredDocRank(d, Cᵢ) defined by formula (6). The top ranked clusters 302 are first presented on the display page, and the top ranked three search results in each of the clusters are first listed.

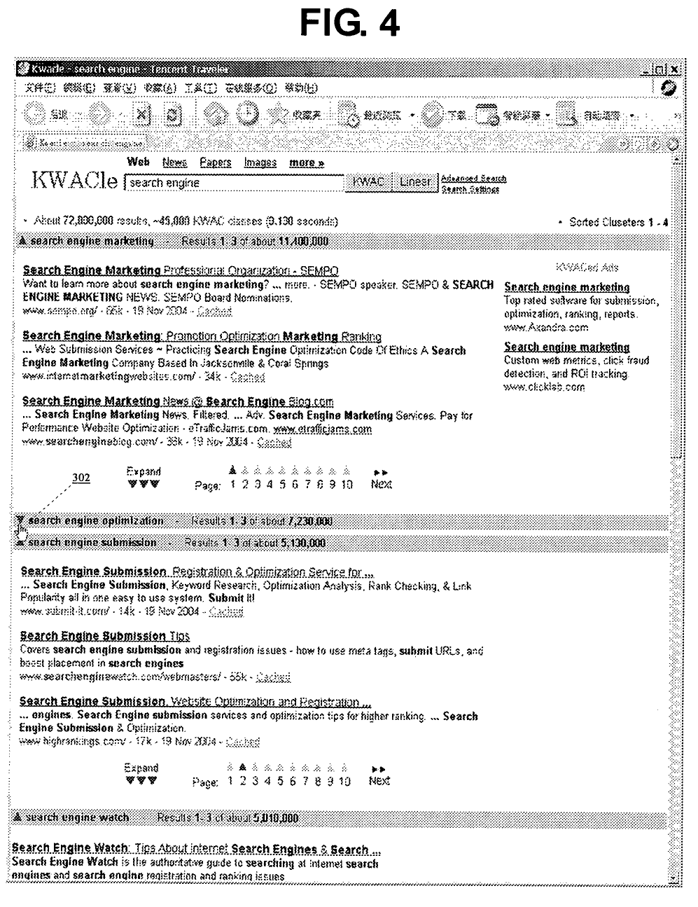

According to the embodiment, the ranked clusters with their included documents are displayed in different subareas 303 of the main page window, with each subarea containing one cluster. The cluster subareas may be implemented as embedded frame subwindows of the main window, such that each cluster's search result list can be independently paged down/up using the page number links 304 of the list. Each of the subareas 303 can be independently opened/closed via clicking a hyperlink set up on the text of the cluster name (to call a snippet of standard HTML scripting code). FIG. 4 is a screen shot illustrating exemplary screen display of FIG. 3 with the second document cluster being independently closed and the following clusters being scrolled up in the main window. Thus, users can choose to close the cluster subareas of no interest and only navigate the search results within interested clusters.

Users can also specify the number of documents in each cluster, the number of clusters as well as the initially opened (or closed) clusters on each display page via setting options that are extensively used by conventional search engines. According to current options, the top four ranked clusters, each including three search results, are presented simultaneously on the first display page.

It will be apparent to one of ordinary skill in the art that aspects of the invention, as described above, may be implemented in many different forms of software and hardware in the embodiments illustrated in the figures. For example, the clustering method of the present invention can be implemented with minor modifications in document retrieval systems that use index structures other than an inverted index. The appended claims cover many variations and alterations of the embodiments consistent with the principles of the invention.

What is claimed is:

1. A method for clustering a set of documents that are obtained as the search results in response to a search query from a searcher using a computer or computer network, said search results are selected, based on the relevance to the search query, from a plurality of documents that are indexed with a set of keywords, comprising:
a. prior to processing the search query, recording the classes of each indexed document when the document is searched with one or several of keywords, for at least some of the index keywords and some of the indexed documents; and
b. grouping the search results according to said classes of each result document with respect to the keyword or keywords included in the search query.

2. The method of claim 1, wherein the class of a document with respect to an index keyword is a keyword or a set of keywords.

3. The method of claim 2, wherein the class of a document with respect to an index keyword is a keyword selected from the group: a keyword that has collocations with the index keyword in the document, a keyword that has collocations with the index keyword in a predetermined phrase library, a keyword that occurs in the document title, and a keyword that occurs in link text of the hyperlinks in other documents that point to present document.

4. The method of claim 1, wherein each class has a weight, denoting the importance degree of the class to the document when it is search with the index keyword.

5. The method of claim 1, wherein the class set of an indexed document with respect to an index keyword or keyword phrase forms an entry of the inverted list of the index keyword, wherein the entry is stored independently, or is linked to the inverted index via an extended pointer field.

6. The method of claim 1, wherein for search queries consisting of a single keyword, the clusters of a document with respect to the query are its classes with respect to the search keyword, and a document in the search results is put into each of the clusters;
for search queries consisting of multiple keywords with the logic” AND relation”, the clusters of a document with respect to the query are the union of the class sets of the document with respect to each of the query keywords;
for search queries consisting of multiple keywords with the logic “OR relation”, the clusters of a document with respect to the query are the class set of the document with respect to the query keyword that the document contains; and
for search queries consisting of multiple keywords, wherein some of the keywords are of the logic “NOT relation”, the clusters of a document with respect to the query are determined as described above with the query keywords that are not of the logic “NOT relation”.

7. The method of claim 6, wherein the rank of a document in a cluster is determined by its rank as a selection from the group consisting of: its rank prior to clustering and the weight of its class corresponding to this cluster, its rank prior to clustering and the number of times the class corresponding to this cluster appears in all of its class sets that are associated with the keywords in the query, and its rank prior to clustering and the number of the keywords in the query that are mutually the clustering classes of each other in the document's clustering class records.

8. The method of claim 7, wherein the rank of each cluster are computed with the ranks of documents that are included by this cluster, which is the sum or the average of the ranks of all the documents, or a certain number of the top ranked documents, that are included by the cluster.

9. The method of claim 8, wherein clusters are sorted by their ranks, and the documents in each cluster are sorted by their ranks, and clusters with higher ranks and documents with higher ranks in each cluster are preferentially presented.

10. The method of claim 9, wherein document clusters are presented in different subareas of the display page, and each cluster's search result list are independently navigated using page number links, and each cluster subarea may be independently opened or closed.
